(19) United States
(12) Patent Application Publication
(10) Pub. No.: US 2013/0122353 A1
(43) Pub. Date: May 16, 2013

(54) SECONDARY BATTERY

(71) Applicants: Daisuke Kawasaki, Tokyo (JP); Masahiro Suguro, Tokyo (JP); Midori Shimura, Tokyo (JP); Kazuaki Matsumoto, Tokyo (JP); Yoko Hashizume, Tokyo (JP)

(72) Inventors: Daisuke Kawasaki, Tokyo (JP); Masahiro Suguro, Tokyo (JP); Midori Shimura, Tokyo (JP); Kazuaki Matsumoto, Tokyo (JP); Yoko Hashizume, Tokyo (JP)

(73) Assignee: NEC CORPORATION, Tokyo (JP)

(21) Appl. No.: 13/812,095

(22) PCT Filed: Aug. 22, 2011
(86) PCT No.: PCT/JP2011/068877

§ 371 Date: Jan. 24, 2013

(30) Foreign Application Priority Data
Sep. 2, 2010 (JP) 2010-196626

(51) Int. Cl. H01M 10/0585

(52) U.S. Cl. CPC H01M 10/0585
USPC 429/163

(57) ABSTRACT

An object of the invention is to provide a secondary battery having satisfactory high-temperature cycle characteristics. The present invention relates to a laminate type secondary battery including an electrode element containing an electrode pair in which a positive electrode and a negative electrode are arranged so as to face each other, an electrolyte and a jacket housing the electrode element and the electrolyte, in which the negative electrode includes a negative-electrode active material containing at least one of a metal (a) capable of forming an alloy with lithium and a metal oxide (b) capable of absorbing and desorbing lithium ions, a negative electrode binder and a negative electrode current collector; the electrolyte contains a nonaqueous solvent and biphenyl; and the content of the biphenyl in the electrolyte is 0.5 to 2.5% by mass, based on the total of the nonaqueous solvent and the biphenyl.

### TECHNICAL FIELD

The present invention relates to a secondary battery.

### BACKGROUND ART

With rapid expansion of e.g., notebook computer, mobile phone and electric car markets, high energy-density secondary batteries have been desired. To enhance energy density, it is proposed to use a negative electrode material having a large capacity and a nonaqueous electrolyte excellent in stability.

Patent Literature 1 discloses use of an oxide of silicon or silicate as a negative electrode active material of a secondary battery.

Patent Literature 2 discloses a secondary-battery negative electrode having a carbon material particle capable of absorbing and desorbing lithium ions, a metal particle capable of alloying with lithium, and an active material layer containing an oxide particle capable of absorbing and desorbing lithium ions.

Patent Literature 3 discloses a secondary-battery negative electrode material formed by coating the surface of particles having a structure in which silicon fine crystals are dispersed in a silicon compound, with carbon.

Patent Literature 4 describes a negative electrode for a lithium secondary battery containing an active material particle containing a silicon and/or silicon alloy having a predetermined average particle size and particle size distribution, and a polyimide serving as a binder.

Patent Literature 5 describes a negative electrode for a nonaqueous electrolyte secondary battery containing a Si-containing active material, a polyimide and polyacrylic acid serving as a binder and a carbon material serving as a conductive material.

Patent Literature 6 describes use of a liquid electrolyte containing 2.5% by mass of biphenyl in a lithium battery in order to prevent overcharge.

Patent Literature 7 describes use of a nonaqueous electrolyte containing an alkyl biphenyl in an amount of 0.01% by mass or more and less than 1.0% by mass in a lithium secondary battery in order to prevent overcharge.

Patent Literature 8 describes biphenyl as an example of additives which are added to an electrolyte in order to improve safety and characteristics such as charge-discharge cycle characteristics and high-temperature storage characteristics in a lithium secondary battery using a polyimide, polyamide-imide or a polyamide serving as a negative electrode binder.

### CITATION LIST

### Patent Literature

Patent Literature 1: JP6-325765A
Patent Literature 2: JP2003-123740A
Patent Literature 3: JP2004-47404A
Patent Literature 4: JP2004-22433A
Patent Literature 5: JP2007-95670A
Patent Literature 6: JP9-106835A
Patent Literature 7: JP2002-260725A
Patent Literature 8: JP2009-152037A

### SUMMARY OF INVENTION

### Technical Problem

However, the secondary battery, which is described in Patent Literature 1, using silicon oxide as a negative electrode active material has a problem in that if the secondary battery is charged or discharged at 45° C. or more, capacity reduction due to a charge-discharge cycle significantly increases.

In the secondary battery negative electrode described in Patent Literature 2, stress and distortion due to volume change caused by absorption and desorption of lithium are mitigated; however, there was room for studying improvement of characteristics of the secondary battery using such a negative electrode. The secondary battery negative electrode material described in Patent Literature 3 has an effect of suppressing volume change of the entire negative electrode caused by absorption and desorption of lithium; however, characteristics of a secondary battery using such a negative electrode material are not sufficient. There was room for studying them.

The characteristics of the secondary batteries using the secondary battery negative electrodes described in Patent Literature 4 and Patent Literature 5 are not sufficient. There was room for studying them.

The secondary batteries described in Patent Literatures 6 and 7 have a certain level of overcharge preventing effect; however, there was room for studying other battery characteristics. Also in the secondary battery described in Patent Literature 8, there was room for studying particularly charge-discharge cycle characteristics.

In particular, a laminate type lithium ion secondary battery using silicon or a silicon oxide as a negative-electrode active material has a problem in that cycle characteristics decrease, for example, if it is charged or discharged under a high temperature environment, the secondary battery bulges. Development of a technique that can overcome the problem has been desired.

An object of the invention is to provide a secondary battery having satisfactory high-temperature cycle characteristics.

### Solution to Problem

A secondary battery according to an aspect of the present invention is a laminate type secondary battery including: an electrode element containing an electrode pair in which a positive electrode and a negative electrode are arranged so as to face each other; an electrolyte; and a jacket housing the electrode element and the electrolyte,

in which the negative electrode includes a negative-electrode active material containing at least one of a metal (a) capable of forming an alloy with lithium and a metal oxide (b) capable of absorbing and desorbing lithium ions, a negative electrode binder and a negative electrode current collector;

the electrolyte contains a nonaqueous solvent and biphenyl; and the content of the biphenyl in the electrolyte is 0.5 to 2.5% by mass, based on the total of the nonaqueous solvent and the biphenyl.

### Advantageous Effects of Invention

According to an exemplary embodiment of the present invention, it is possible to provide a nonaqueous electrolyte secondary battery having satisfactory high-temperature cycle characteristics.

### BRIEF DESCRIPTION OF DRAWINGS

FIG. 1 is a schematic sectional view for describing a structure of a laminate type secondary battery in accordance with an exemplary embodiment of the present invention.

### DESCRIPTION OF EMBODIMENTS

An exemplary embodiment of the present invention will be specifically described below.

A secondary battery in accordance with the exemplary embodiment is a laminate type secondary battery including an electrode element (electrode laminate) which contains a positive electrode, a separator and a negative electrode arranged so as to face to the positive electrode with the separator interposed between them, an electrolyte, and a jacket housing these. The electrode element may contain a single or two or more electrode pairs each including a positive electrode and a negative electrode.

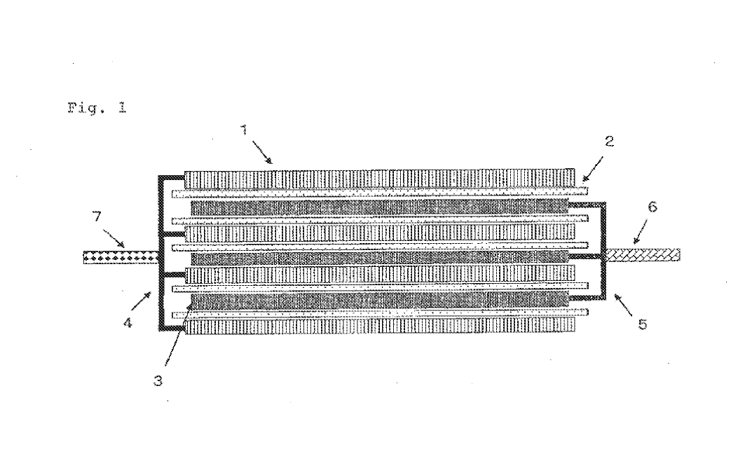

FIG. 1 is a schematic sectional view showing an example of an electrode element of such a laminate type secondary battery. The electrode element includes a plurality of positive electrodes 3 and a plurality of negative electrodes 1, and the positive electrodes and the negative electrodes are alternately laminated with each separator 2 interposed between them. Positive electrode current collectors 5 of the positive electrodes 3 are mutually welded and electrically connected at the end portions not coated with the positive electrode active material. Further, to the welded portion, a positive electrode terminal 6 is welded. Negative electrode current collectors 4 of the negative electrodes 1 are mutually welded and electrically connected at the end portions not coated with the negative electrode active material. Further, to the welded portion, a negative electrode terminal 7 is welded. The electrode element is packaged with a laminate film and an electrolyte is injected and sealed.

The electrode element having such a planar laminate structure has the following advantage. Since it does not have a small R portion (e.g., a region close to a winding core of a winding structure), compared to an electrode element having a winding structure, the electrode element is rarely affected by volume change of the electrode caused by charge-discharge. In other words, the electrode element is effective in the case of using an active material likely causing volume expansion. In contrast, in the electrode element having a winding structure, since the electrodes are curved, the structure tends to deform when volume change occurs. In particular, in the case of using a negative electrode active material such as a silicon and a silicon oxide causing a large volume change due to charge-discharge in a secondary battery using an electrode element having a winding structure, capacity reduction due to charge-discharge becomes significant. Note that, “planar laminate structure” means that each laminated electrode has a sheet-like shape and the electrodes are each laminated while keeping a flat figure (the electrodes are laminated such that the outer peripheral edges of sheet-like bodys thereof constitute the peripheral edge portion of the laminate), and the structure is distinguished from a folded structure and a winding structure of a laminate (electrode element).

However, the secondary batteries using an electrode element having a planar laminate structure have the following problem. If gas is generated between electrodes, the gas is likely to remain between the electrodes. In an electrode element having a winding structure, the interval between the electrodes is rarely widened because tension is applied to the electrodes, whereas in an electrode element having a laminate structure, the interval between the electrodes tends to be widened. If the jacket is formed of an aluminum laminate film, this problem becomes particularly significant.

According to the exemplary embodiment, the aforementioned problem can be solved and a laminate type lithium ion secondary battery using a high-energy negative electrode which tends to generate a gas can be also used for a long time.

### [1] Negative Electrode

As the negative electrode in accordance with the exemplary embodiment, a negative electrode in which a negative-electrode active material layer containing a negative-electrode active material and a negative electrode binder is provided on a negative electrode current collector can be used. In the exemplary embodiment, at least one of a metal (a) capable of forming an alloy with lithium and a metal oxide (b) capable of absorbing and desorbing lithium ions is contained as the negative-electrode active material. More specifically, the negative-electrode active material may contain either one of a metal (a) and a metal oxide (b), and preferably contains both of a metal (a) and a metal oxide (b). The negative-electrode active material may further contain a carbon material (c) and more preferably contains a metal (a), a metal oxide (b) and a carbon material (c).

As the metal (a), Al, Si, Pb, Sn, In, Bi, Ag, Ba, Ca, Hg, Pd, Pt, Te, Zn, La or an alloy of two types or more of these can be used. In particular, as the metal (a), silicon (Si) is preferably contained.

The content of the metal (a) in the negative-electrode active material may be 0% by mass or 100% by mass, and the content is preferably 5% by mass or more, more preferably 10% by mass or more and further preferably 20% by mass or less in view of obtaining sufficient addition effect. In view of obtaining sufficient addition effect of other components, the content is preferably 95% by mass or less, more preferably 90% by mass or less and further preferably 80% by mass or less. The content may be set at 50% by mass or less.

As the metal oxide (b), silicon oxide, aluminum oxide, tin oxide, indium oxide, zinc oxide, lithium oxide or a composite of these can be used. In particular, as the metal oxide (b), silicon oxide is preferably contained. This is because silicon oxide is relatively stable and rarely causes a reaction with another compound. Moreover, to the metal oxide (b), a single or two types or more elements selected from nitrogen, boron and sulfur can be added, for example, in an amount of 0.1 to 5% by mass. In this manner, the electric conductivity of the metal oxide (b) can be improved. The content of the metal oxide (b) in the negative-electrode active material may be 0% by mass or 100% by mass, and the content is preferably 5% by mass or more, more preferably 15% by mass or more and further preferably 40% by mass or more, in view of obtaining sufficient addition effect. The content may be set at 50% by mass or more. In view of obtaining sufficient addition effect of other components, the content is preferably 90% by mass or less, more preferably 80% by mass or less and further preferably 70% by mass or less.

It is preferable that the metal oxide (b) wholly or partly has an amorphous structure. The metal oxide (b) having an amorphous structure can suppress volume expansion of other negative electrode active material, i.e., a carbon material (c) and a metal (a) and also suppress decomposition of an electrolyte containing a phosphate compound. Although the mechanism of this is unclear, the amorphous structure of the metal oxide (b) may probably have some effect on formation of a film on the interface between the carbon material (c) and an electrolyte. Furthermore, the amorphous structure is relatively free from factors due to non-uniformity such as crystal grain boundary and defects. Note that whether whole or part of the metal oxide (b) has an amorphous structure can be checked by X-ray diffraction analysis (general XRD analysis). Specifically, if the metal oxide (b) does not have an amorphous structure, a peak intrinsic to the metal oxide (b) is observed, whereas if the whole or part of the metal oxide (b) has an amorphous structure, it is observed that the peak intrinsic to the metal oxide (b) becomes broader.

Furthermore, in the case where a negative-electrode active material contains a metal (a) and a metal oxide (b), it is preferable that the metal (a) is wholly or partly dispersed in the metal oxide (b). If at least a portion of the metal (a) is dispersed in the metal oxide (b), the volume expansion of the entire negative electrode can be further suppressed and also suppress decomposition of an electrolyte. Note that whether the whole or part of the metal (a) is dispersed in the metal oxide (b) can be checked by using transmission electron microscopic observation (general TEM observation) and energy dispersive X-ray spectrometry analysis (general EDX analysis) in combination. More specifically, this can be checked by observing a section of a sample containing metal (a) particles and measuring the oxygen concentration of the metal (a) particles dispersed in the metal oxide (b) to confirm that the metal constituting the metal (a) particle is not converted into an oxide.

Furthermore, in the case where a negative-electrode active material contains a metal (a) and a metal oxide (b), the metal oxide (b) is preferably an oxide of the metal constituting the metal (a). In particular, it is preferable that the metal (a) is an elemental silicon, and the metal oxide (b) is a silicon oxide.

A negative-electrode active material containing a metal (a) and a metal oxide (b), a negative-electrode active material containing a metal (a) and a carbon material (c), a negative-electrode active material containing a metal oxide (b) and a carbon material (c), and a negative-electrode active material containing a metal (a), a metal oxide (b) and a carbon material (c) can be prepared, for example, by mixing two or more elements selected from a metal (a), a metal oxide (b) and a carbon material (c) by mechanical milling, and may be prepared by mixing them by a general mixing method.

A negative-electrode active material containing a metal (a), a metal oxide (b) and a carbon material (c), in which the metal oxide (b) is wholly or partly formed of an amorphous structure and the metal (a) is wholly or partly dispersed in the metal oxide (b), can be prepared, for example, by the method disclosed in Patent Literature 3 (JP2004-47404A). More specifically, a metal oxide (b) is disproportionated under an atmosphere containing an organic gas such as methane gas at 900 to 1400 and simultaneously treated with thermal CVD to obtain a composite in which the metal (a) in the metal oxide (b) is nano-clustered and having a surface coated with a carbon material (c). Furthermore, the negative-electrode active material mentioned above can be also prepared by mixing a metal (a), a metal oxide (b) and a carbon material (c) by mechanical milling.

In the case where a negative-electrode active material contains a metal (a) and a metal oxide (b), the mass ratio (a/b) of the metal (a) and the metal oxide (b) in the negative-electrode active material is not particularly limited, but can be set within the range of 5/95 to 90/10, also within the range of 10/90 to 80/20 and further within the range of 30/70 to 60/40.

As a carbon material (c), graphite, amorphous carbon, diamond-form carbon, carbon nano-tube, or a composite of two types or more of these can be used. Herein, graphite having a high crystallinity has a high electric conductivity, excellent adhesiveness with a positive electrode current collector formed of a metal such as copper, and excellent voltage planarity. In contrast, when amorphous carbon having low crystallinity is used, since it has a relatively small volume expansion, the effect of mitigating the volume expansion of the entire negative electrode is high, and deterioration caused by non-uniformity such as a crystal grain boundary and a defect, rarely occurs.

The content of a carbon material (c) in a negative-electrode active material may be 0% by mass; however, in view of obtaining sufficient addition effect, the content is preferably 1% by mass or more and more preferably 2% by mass or more. In view of obtaining sufficient addition effect of other components, the content is preferably 50% by mass or less and more preferably 30% by mass or less.

In the case where a negative-electrode active material contains a metal (a), a metal oxide (b) and a carbon material (c), the ratio of the metal (a), metal oxide (b) and carbon material (c) is not particularly limited, but can be set in accordance with the aforementioned ranges of the contents. The content ratio of the metal (a) is preferably, for example, 5% by mass or more, more preferably 10% by mass or more and further preferably 20% by mass or more, and also preferably 90% by mass or less, more preferably 80% by mass or less and further preferably 50% by mass or less, based on the total of the metal (a), metal oxide (b) and carbon material (c). The content ratio of the metal oxide (b) is preferably, for example, 5% by mass or more, more preferably 15% by mass or more and further preferably 40% by mass or more, and also preferably 90% by mass or less, more preferably 80% by mass or less and further preferably 70% by mass or less, based on the total of the metal (a), metal oxide (b) and carbon material (c). The content ratio of the carbon material (c) is preferably 1% by mass or more and more preferably 2% by mass or more, and also preferably 50% by mass or less and more preferably 30% by mass or less, based on the total of the metal (a), metal oxide (b) and carbon material (c).

The forms of the metal (a), metal oxide (b) and carbon material (c) are not particularly limited; however, particulate forms can be used. For example, the average particle size of the metal (a) can be set to be smaller than the average particle size of the carbon material (c) and the average particle size of the metal oxide (b). If so, the metal (a), which is large in volume change during a charge-discharge time, is present in a relatively small particle size; whereas the metal oxide (b) and carbon material (c), which are small in volume change, are present in relatively large particle sizes. Thus, production of dendrite and pulverization of an alloy can be effectively suppressed. Furthermore, during a charge-discharge process, lithium is absorbed or desorbed sequentially in the order of a large-size particle, a small-size particle and a large-size particle. Also in this respect, occurrence of residual stress and residual strain is suppressed. The average particle size of the metal (a) can be set, for example, at 20 μm or less and preferably 15 μm or less. The average particle size herein is 50% cumulative size D₅₀ (median size) obtained using particle size distribution measurement by laser diffraction scattering.

Furthermore, the average particle size of a metal oxide (b) is preferably ½ or less of the average particle size of a carbon material (c). The average particle size of a metal (a) is preferably ½ or less of the average particle size of a metal oxide (b). Furthermore, it is preferable that the average particle size of a metal oxide (b) is ½ or less of the average particle size of a carbon material (c) and the average particle size of a metal (a) is ½ or less of the average particle size of a metal oxide (b). If the average particle size is controlled to fall within the aforementioned ranges, the relaxation effect of volume expansion of a metal and an alloy phase can be more effectively obtained and a secondary battery having excellent balance between energy density, cycle life and efficiency can be obtained. More specifically, it is preferable that the average particle size of a silicon oxide (b) is set at ½ or less of the average particle size of graphite (c) and the average particle size of silicon (a) is set at ½ or less of the average particle size of a silicon oxide (b). Much more specifically, the average particle size of silicon (a) can be set at, for example, 20 μm or less, and preferably sets at 15 μm or less.

The average particle size of a negative-electrode active material is preferably 0.01 μm or more, more preferably 0.1 μm or more and further preferably 0.2 μm or more, and also preferably 30 μm or less and more preferably 20 μm or less. The average particle size herein is a 50% cumulative size D₅₀ (median size) and can be obtained using particle size distribution measurement by laser diffraction scattering. The specific surface area of a negative-electrode active material is preferably 0.2 m²/g or more, more preferably 1.0 m²/g or more and further preferably 2.0 m²/g or more, and also preferably 9.0 m²/g or less, more preferably 8.0 m²/g or less and further preferably 7.0 m²/g or less. The specific surface area herein can be obtained by a conventional BET specific surface area measurement method.

As the negative electrode binder, e.g., polyvinylidene fluoride, a vinylidene fluoride-hexafluoropropylene copolymer, a vinylidene fluoride-tetrafluoroethylene copolymer, a styrene-butadiene copolymer rubber, polytetrafluoroethylene, polypropylene, polyethylene, polyimide and polyamide-imide can be used. Of them, polyimide or polyamide-imide is preferable since binding property is high. The content of the negative electrode binder to be used is preferably 5 to 25 parts by mass, based on 100 parts by mass of the negative electrode active material in consideration of the trade-off relationship between “sufficient binding property” and “high energy production”.

As a negative electrode current collector, in view of electrochemical stability, aluminum, nickel, copper, silver, and an alloy of these are preferable. As the form of the current collector, foil, flat-plate and mesh form are mentioned.

The negative electrode can be prepared by forming a negative-electrode active material layer containing a negative-electrode active material and a negative electrode binder, for example, on a negative electrode current collector. As a method for forming a negative-electrode active material layer, a doctor blade method, a general slurry coating method using a die coater method, a CVD method and a sputtering method are mentioned. A negative electrode active material layer is formed in advance, and then, a thin film of aluminum, nickel or an alloy of them may be formed by a method such as vapor deposition or sputtering to form a negative electrode current collector. As a slurry coating method, for example, slurry containing a negative-electrode active material, a binder and a solvent is prepared, and then, the slurry is applied onto a current collector, dried, and, if necessary, compressed and molded to form a negative electrode.

### [2] Positive Electrode

As the positive electrode, for example, a positive electrode prepared by providing a positive electrode active material layer, containing a positive electrode active material and a positive electrode binder, on a positive electrode current collector, can be used.

Examples of the positive electrode active material can include lithium manganites having a laminate structure or a spinel structure such as LiMnO₂ and LiₓMn₂O₄ (0<x<2); lithium metal oxides obtained by replacing part of Mn of lithium manganites with other metals; LiCoO₂, LiNiO₂, or lithium metal oxides obtained by replacing part of transition metals (Co, Ni) of these with other metals; lithium transition metal oxides such as LiNi_{1/3}Co_{1/3}Mn_{1/3}O₂ in which a specific transition metal does not exceed a half (atomic number ratio) of the whole transition metals; and lithium metal oxides containing Li in an excessively larger amount than the stoichiometric composition in these lithium transition metal oxides. Of them, Li_{α}Ni_{β}Co_{γ}Al_{δ}O₂ (0.8≦α≦1.2, β+γ+δ=1, 0.5<β, 0<γ, 0<δ) or Li_{α}Ni_{β}Co_{γ}Mn_{δ}O₂(0.8≦α≦1.2, β+γ+δ=1, 0.5<β, 0<γ, 0<δ) can be preferably used. In these lithium metal oxides, γ can be set to be equal to or greater than 0.1 and δ can be set to be equal to or greater than 0.01. In particular, Li_{α}Ni_{β}Co_{δ}Al_{δ}O₂ (1≦α≦1.2, β+γ+δ=1, β≧0.7, γ≧0.2), or Li_{α}Ni_{β}Co_{γ}Mn_{δ}O₂ (1≦α1.2, β+γ+δ=1, β≧0.6, γ≦0.2) is preferable. The positive electrode active materials can be used alone or in combination of two types or more.

As the positive electrode binder, the same compounds as conventional negative electrode binders can be used. Of them, in view of general versatility and low cost, polyvinylidene fluoride is preferable. The amount of positive electrode binder to be used is preferably 2 to 10 parts by mass, based on 100 parts by mass of the positive electrode active material in consideration of the trade-off relationship between “sufficient binding property” and “high energy production”.

As the positive electrode current collector, that which is the same as used in a negative electrode current collector can be used. For example, aluminum foil can be used.

To a positive electrode active material layer including a positive electrode active material, in order to reduce impedance, a conductive aid may be added. Examples of the conductive aid include carbonaceous fine particles of graphite, carbon black and acetylene black.

A positive electrode can be formed, for example, as follows. Slurry containing a positive electrode active material, a binder, a solvent, and, if necessary, a conductive aid is prepared. The slurry is applied onto a current collector and dried to form a positive electrode active material layer on the current collector. The obtained electrode can be compressed by a method such as roll press so as to obtain an appropriate density. As a solvent, N-methyl-2-pyrrolidone can be used.

### [3] Electrolyte

The electrolyte to be used in the exemplary embodiment contains a nonaqueous solvent and biphenyl. The content of biphenyl in the electrolyte is 0.5 to 2.5% by mass (preferably, 1 to 2% by mass), based on the total of a nonaqueous solvent and biphenyl.

As described above, in the case where metal (a) such as silicon or a metal oxide (b) such as a silicon oxide were used as a negative-electrode active material, CO₂ is generated from a negative electrode by a charge-discharge cycle and accumulated between electrodes, particularly, in a laminate type secondary battery. As a result, the whole secondary battery is swollen, causing a reduction in capacity as a problem. In contrast, biphenyl is decomposed at the time of overcharge to generate a gas to open a cell and thus so far used as an overcharge inhibitor. Thus, it is considered that if biphenyl is added, cycle characteristics may not be improved. However, as a matter of fact, it was found that if a predetermined amount of biphenyl is added to an electrolyte, a film is formed on a negative electrode surface, suppressing generation of CO₂ by a charge-discharge cycle. In a method of related technique, a polymerization reaction of biphenyl during high voltage application time was used; whereas, in the exemplary embodiment, it was found a phenomenon where an electrolyte is reductively decomposed to generate CO₂, which intrinsically occurs in the case where a metal (a) such as silicon or a metal oxide (b) such as a silicon oxide are used as a negative-electrode active material. To suppress this phenomenon, biphenyl is used.

The electrolyte to be used in the exemplary embodiment includes a nonaqueous solvent stable at an operation voltage of a battery. Examples of the nonaqueous solvent may include aprotonic solvents such as carbonic acid esters (linear or cyclic carbonate) and carboxylic acid esters (linear or cyclic carboxylic acid ester). Specific examples of the carbonic acid ester solvent include cyclic carbonates such as propylene carbonate (PC), ethylene carbonate (EC), butylene carbonate (BC) and vinylene carbonate (VC); linear carbonates such as dimethyl carbonate (DMC), diethyl carbonate (DEC), ethylmethyl carbonate (EMC) and dipropyl carbonate (DPC); and propylene carbonate derivatives. Specific examples of the carboxylic acid ester include aliphatic carboxylic acid esters such as methyl formate, methyl acetate and ethyl propionate. Of these, cyclic or linear carbonates such as ethylene carbonate (EC), propylene carbonate (PC), butylene carbonate (BC), vinylene carbonate (VC), dimethyl carbonate (DMC), diethyl carbonate (DEC), ethylmethyl carbonate (MEC) and dipropyl carbonate (DPC) are preferable. The nonaqueous solvents may be used alone or in combination of two or more.

The nonaqueous solvent further preferably contains a fluorinated ether compound. The fluorinated ether compound has high affinity for Si and can improve cycle characteristics (particularly, capacity retention rate). As the fluorinated ether compound, a fluorinated linear ether compound prepared by substituting part of hydrogen of non-fluorinated linear ether compound with fluorine or a fluorinated cyclic ether compound prepared by substituting part of hydrogen of non-fluorinated cyclic ether compound with fluorine may be used.

Examples of the fluorinated linear ether compound include fluorinated compounds of the following non-fluorinated linear ether compounds: non-fluorinated linear monoether compounds such as dimethyl ether, methyl ethyl ether, diethyl ether, methyl propyl ether, ethyl propyl ether, dipropyl ether, methyl butyl ether, ethyl butyl ether, propyl butyl ether, dibutyl ether, methyl pentyl ether, ethyl pentyl ether, propyl pentyl ether, butyl pentyl ether and dipentyl ether; and non-fluorinated linear diether compounds such as 1,2-dimethoxyethane (DME), 1,2-diethoxyethane (DEE), ethoxymethoxyethane (EME), 1,2-dipropoxyethane, propoxyethoxyethane, propoxymethoxyethane, 1,2-dibutoxyethane, butoxypropoxyethane, butoxyethoxyethane, butoxymethoxyethane, 1,2-dipentoxyethane, pentoxybutoxyethane, pentoxypropoxyethane, pentoxyethoxyethane and pentoxymethoxyethane.

Examples of the fluorinated cyclic ether compound include fluorinated compounds of the following non-fluorinated cyclic ether compounds: fluorinated compounds of non-fluorinated cyclic monoether compounds such as ethylene oxide, propylene oxide, oxetane, tetrahydrofuran, 2-methyltetrahydrofuran, 3-methyltetrahydrofuran, tetrahydropyran, 2-methyltetrahydropyran, 3-methyltetrahydropyran, and 4-methyltetrahydropyran; non-fluorinated cyclic diether compounds such as 1,3-dioxolane, 2-methyl-1,3-dioxolane, 4-methyl-1,3-dioxolane, 1,4-dioxane, 2-methyl-1,4-dioxane, 1,3-dioxane, 2-methyl-1,3-dioxane, 4-methyl-1,3-dioxane, 5-methyl-1,3-dioxane, 2,4-dimethyl-1,3-dioxane and 4-ethyl-1,3-dioxane.

In particular, a fluorinated linear ether compound having a satisfactory stability is preferable. As the linear fluorinated ether compound, it is preferable to employ a compound represented by the following formula (1):

H—(CX¹X²—CX³X⁴)ₙ—CH₂O—CX⁵X⁶—CX⁷X⁸—H (1)

In the formula (1), n is 1, 2, 3 or 4; X¹ to X⁸ are each independently a fluorine atom or a 2 0 hydrogen atom, with the proviso that at least one of X¹ to X⁴ is a fluorine atom and at least one of X⁵ to X⁸ is a fluorine atom. Furthermore, the atomic ratio of fluorine atoms to hydrogen atoms binding to the compound of the formula (1) is 1 or more: (total number of fluorine atoms/total number of hydrogen atoms) 1. Furthermore, the compound represented by the following formula (2) is more preferable.

H—(CF₂—CF₂)ₙ—CH₂O—CF₂—CF₂—H (2)

In the formula (2), n is 1 or 2.

The content of such fluorinated ether compound is preferably 10% by vol. or more and more preferably 15% by vol. or more, and also preferably 75% by vol. or less, more preferably 3 0 70% by vol. or less and further preferably 50% by vol. or less, based on the total nonaqueous solvent (100% by vol.), in view of obtaining sufficient addition effect as long as battery characteristics are not degraded.

As the electrolyte to be used in the exemplary embodiment, a solution prepared by adding a supporting electrolyte to a solution mixture of biphenyl and a nonaqueous solvent can be used. Specific examples of the supporting electrolyte include lithium salts such as LiPF₆, LiAsF₆, LiAlCl₄, LiClO₄, LiBF₄, LiSbF₆, LiCF₃SO₃, LiC₄F₉SO₃, Li(CF₃SO₂)₂ and LiN(CF₃SO₂)₂. The supporting electrolytes can be used singly or in combination of two types or more.

### [4] Separator

As the separator, a porous film and unwoven cloth formed of a polyolefin such as polypropylene and polyethylene and a fluorine resin can be used. Furthermore, they may be laminated and used as the separator.

### [5] Jacket

As the jacket, a laminate film stable in an electrolyte and having a sufficient vapor barrier can be used. For example, a laminate film of e.g., polypropylene or polyethylene coated with aluminum or silica can be used as the jacket. In particular, in view of suppression of volume expansion, an aluminum laminate film is preferably used.

In the case of a secondary battery using a laminate film as a jacket, if gas is generated, deformation of an electrode element becomes significantly large compared to a secondary battery using a metal can as a jacket. This is because the laminate film is easily deformed compared to a metal can by the inner pressure of a secondary battery. Furthermore, in sealing a secondary battery using a laminate film as a jacket, usually, the inner pressure of the battery is lower than the atmospheric pressure, and hence no extra space is present in the interior portion. If gas is generated, it can easily change volume of the battery and deform the electrode element directly.

According to the exemplary embodiment, it is possible to suppress volume change of such a battery and distortion of an electrode element. Accordingly, a laminate type lithium ion secondary battery having an excellent degree of freedom of cell capacity design (cell capacity can be modified by the number of laminate layers) and excellent cycle characteristics can be produced at low cost.

### EXAMPLES

The exemplary embodiment in accordance with the present invention will be described in more details by way of Examples, below.

### Example 1

Silicon having an average particle size of 5 μm and serving as a metal (a) and graphite having an average particle size of 30 μm and serving as a carbon material (c) were weighed in a mass ratio of 90:10 and mixed by so-called mechanical milling for 24 hours to obtain a negative-electrode active material. The negative-electrode active material (an average particle size D₅₀=5 μm) and polyvinylidene fluoride (PVDF, trade name: KF polymer #1300, manufactured by Kureha Corporation) serving as a negative electrode binder were weighed in a mass ratio of 90:10. They were mixed with n-methylpyrrolidone to prepare negative electrode slurry. The negative electrode slurry was applied to copper foil having a thickness of 10 μm, and then dried, and further a heat treatment was applied under a nitrogen atmosphere of 300° C. to prepare a negative electrode.

Lithium nickelate (LiNi_{0.80}Co_{0.15}Al_{0.15}O₂) serving as a positive electrode active material, carbon black serving as a conductive aid and polyvinylidene fluoride serving as a positive electrode binder were weighed so as to satisfy a mass ratio of 90:5:5, and mixed with N-methylpyrrolidone to prepare positive electrode slurry. The positive electrode slurry was applied to aluminum foil having a thickness of 20 μm and then dried, and further pressed to prepare a positive electrode.

The obtained 3 positive electrode layers and 4 negative electrode layers were alternately laminated with each porous polypropylene film serving as a separator interposed between them. The end portions of the positive electrode current collectors not coated with the positive electrode active material were welded each other and the end portions of the negative electrode current collectors not coated with the negative electrode active material were welded each other. To the respective welded portions, a positive electrode terminal made of aluminum and a negative electrode terminal made of nickel were attached by welding to obtain an electrode element having a planar laminate structure.

On the other hand, a carbonate based nonaqueous solvent (99.5 parts by mass) composed of EC/PC/DMC/EMC/DEC=20/20/20/20/20 (volume ratio) and biphenyl (0.5 parts by mass) (the content of biphenyl: 0.5% by mass) were mixed. In this, LiPF₆ serving as a supporting electrolyte was further dissolved in a concentration of 1 mol/l to obtain an electrolyte.

The above electrode element was packaged with an aluminum laminate film serving as a jacket and the electrolyte was injected within the jacket. Thereafter, the inner pressure of the jacket was reduced up to 0.1 atm, and sealed to prepare a secondary battery.

### Examples 2 to 5

Secondary batteries were prepared in the same manner as in Example 1 except that the content of biphenyl was changed to 1.0% by mass in Example 2, 1.5% by mass in Example 3, 2.0% by mass in Example 4, and 2.5% by mass in Example 5.

### Examples 6 to 10

An amorphous silicon oxide (SiOₓ, 0<x≦2) having an average particle size of 13 μm and serving as a metal oxide (b) and graphite having an average particle size of 30 μm and serving as a carbon material (c) were weighed in a mass ratio of 90:10 and mixed by so-called mechanical milling for 24 hours to obtain a negative-electrode active material. In Examples 6 to 10, secondary batteries were prepared in the same manners as in Examples 1 to 5, respectively, except that the negative-electrode active material (an average particle size D₅₀=5 μm) was used.

### Examples 11 to 15

Silicon having an average particle size of 5 μm and serving as a metal (a), a crystalline silicon oxide (SiO₂) having an average particle size of 13 μm and serving as a metal oxide (b) and graphite having an average particle size of 30 μm and serving as a carbon material (c) were weighed in a mass ratio of 29:61:10 and mixed by so-called mechanical milling for 24 hours to obtain a negative-electrode active material. Note that, in the negative-electrode active material, silicon serving as a metal (a) was dispersed in the crystalline silicon oxide serving as a metal oxide (b). In Examples 11 to 15, secondary batteries were prepared in the same manners as in Examples 1 to 5, respectively, except that the negative-electrode active material (an average particle size D₅₀=5 μm) was used.

### Examples 16 to 20

Silicon having an average particle size of 5 μm and serving as a metal (a) and an amorphous silicon oxide (SiOₓ, 0<x≦2) having an average particle size of 13 μm and serving as a metal oxide (b) were weighed in a mass ratio of 32:68 and mixed by so-called mechanical milling for 24 hours to obtain a negative-electrode active material. Note that, in the negative-electrode active material, silicon serving as a metal (a) was dispersed in the silicon oxide (SiOₓ, 0<x≦2) serving as a metal oxide (b). In Examples 16 to 20, secondary batteries were prepared in the same manners as in Examples 1 to 5, respectively, except that the negative-electrode active material (an average particle size D₅₀=5 μm) was used.

### Examples 21 to 40

In Examples 21 to 40, secondary batteries were prepared in the same manners as in Examples 1 to 20, respectively, except that polyimide (PI, trade name: U Varnish A, manufactured by Ube Industries, Ltd.) was used as a negative electrode binder.

### Examples 41 and 42

In Examples 41 and 42, secondary batteries were prepared in the same manners as in Examples 33 and 34, respectively, except that polyamide-imide (PAI, trade name: VYLOMAX (registered trademark) manufactured by Toyobo Co., Ltd.) was used as a negative electrode binder.

### Comparative Examples 1 to 8

In Comparative Examples 1 to 8, secondary batteries were prepared in the same manners as in Examples 1, 6, 11, 16, 21, 26, 31 and 36, respectively, except that biphenyl was not added.

### Comparative Examples 9 to 16

Secondary batteries were prepared in the same manners as in Examples 1, 6, 11, 16, 21, 26, 31 and 36, respectively, except that the content of biphenyl was set at 3.0% by mass.

### Examples 43 to 47

Silicon having an average particle size of 6 μm serving as a metal (a), an amorphous silicon oxide (SiOₓ, 0<x≦2) having an average particle size of 13 μm and serving as a metal oxide (b) and graphite having an average particle size of 30 μm and serving as a carbon material (c) were weighed in a mass ratio of 29:61:10. The powder mixture was directly used as a negative-electrode active material without applying a specific treatment thereto. Note that, in the negative-electrode active material, silicon serving as a metal (a) was not dispersed in a silicon oxide (SiOₓ, 0<x≦2) serving as a metal oxide (b). In Examples 43 to 47, secondary batteries were prepared in the same manners as in Examples 31 to 35, respectively, except that the negative-electrode active material was used.

### Examples 48 to 52

Silicon having an average particle size of 5 μm and serving as a metal (a), an amorphous silicon oxide (SiOₓ, 0 <x≦2) having an average particle size of 13 μm and serving as a metal oxide (b) and graphite having an average particle size of 30 μm and serving as a carbon material (c) were weighed in a mass ratio of 29:61:10 and mixed by so-called mechanical milling for 24 hours to obtain a negative-electrode active material. Note that, in the negative-electrode active material, silicon serving as a metal (a) was dispersed in the silicon oxide (SiOₓ, 0<x≦2) serving as a metal oxide (b). In Examples 48 to 52, secondary batteries were prepared in the same manners as in Examples 31 to 35, respectively, except that the negative-electrode active material (an average particle size D₅₀=5 μm) was used.

### Examples 53 and 54

In Examples 53 and 54, secondary batteries were prepared in the same manners as in Examples 50 and 51, respectively, except that a nonaqueous solvent composed of EC/PC/DMC/EMC/DEC/fluorinated ether compound=10/10/10/10/10/50 (volume ratio) was used. Note that, H—CF₂CF₂—CH₂O—CF₂CF₂—H was used as the fluorinated ether compound.

### Examples 55 to 61

A negative-electrode active material containing silicon, an amorphous silicon oxide (SiOₓ, 0<x≦2) and carbon in a mass ratio of 29:61:10 was obtained in accordance with the method described in Patent Literature 3. Note that, in the negative-electrode active material, silicon serving as a metal (a) was dispersed in the amorphous silicon oxide serving as a metal oxide (b). In Examples 55 to 61, secondary batteries were prepared in the same manners as in Examples 48 to 54, respectively, except that the negative-electrode active material was used.

(Evaluation of Cycle Characteristics)

Secondary batteries prepared in Examples 1 to 61 and Comparative Examples 1 to 16 were checked for high-temperature cycle characteristics. To describe more specifically, a charge-discharge test of a secondary battery was repeated 50 times in a constant temperature vessel kept at 60° C. within the voltage range of 2.5 V to 4.1 V. Then, the rate of (discharge capacity at 50th cycle)/(discharge capacity at 5th cycle) was calculated as a retention rate (%). Furthermore, a rate of increased volume of battery at 50th cycle relative to volume of battery before the charge-discharge cycle was calculated as a bulge rate (%). The volume increase amount was obtained by the Archimedes method. A secondary battery was hanged to a scale and sunk in deionized water. From a reduction in mass herein, volume can be calculated. The results are shown in Tables 1 to 3.

A retention rate of 75% or more was evaluated as “AA”, a retention rate of 50% or more and less than 75% as “A”, a retention rate of 25% or more and less than 50% as “B” and a retention rate of less than 25% as “C”. A bulge rate of less than 5% was evaluated as “AA”, a bulge rate of 5% or more and less than 10% as “A”, a bulge rate of 10% or more and less than 20% as “B”, and a bulge rate of 20% or more as “C”.

TABLE 1

| | Negative | | | | | | |
|---|---|---|---|---|---|---|---|
| | electrode | | | | | | |
| | active material | Negative | | Cycle characteristics at 60° C. | | | |
| | Si/SiOₓ/C | electrode | Biphenyl | Retention rate | | Bulge rate | |
| | (wt ratio) | binder | content (wt %) | % | Evaluation | % | Evaluation |
| Example 1 | 90/0/10 | PVDF | 0.5 | 41 | B | 6 | A |
| Example 2 | 90/0/10 | PVDF | 1.0 | 40 | B | 5 | A |
| Example 3 | 90/0/10 | PVDF | 1.5 | 40 | B | 5 | A |
| Example 4 | 90/0/10 | PVDF | 2.0 | 41 | B | 9 | A |
| Example 5 | 90/0/10 | PVDF | 2.5 | 41 | B | 9 | A |
| Example 6 | 0/90/10 | PVDF | 0.5 | 46 | B | 5 | A |
| Example 7 | 0/90/10 | PVDF | 1.0 | 44 | B | 7 | A |
| Example 8 | 0/90/10 | PVDF | 1.5 | 44 | B | 7 | A |
| Example 9 | 0/90/10 | PVDF | 2.0 | 46 | B | 5 | A |
| Example 10 | 0/90/10 | PVDF | 2.5 | 44 | B | 7 | A |
| Example 11 | 29/61/10 | PVDF | 0.5 | 49 | B | 6 | A |
| Example 12 | 29/61/10 | PVDF | 1.0 | 43 | B | 8 | A |
| Example 13 | 29/61/10 | PVDF | 1.5 | 49 | B | 6 | A |
| Example 14 | 29/61/10 | PVDF | 2.0 | 49 | B | 6 | A |
| Example 15 | 29/61/10 | PVDF | 2.5 | 43 | B | 8 | A |
| Example 16 | 32/68/0 | PVDF | 0.5 | 43 | B | 7 | A |
| Example 17 | 32/68/0 | PVDF | 1.0 | 45 | B | 5 | A |
| Example 18 | 32/68/0 | PVDF | 1.5 | 43 | B | 7 | A |
| Example 19 | 32/68/0 | PVDF | 2.0 | 45 | B | 5 | A |
| Example 20 | 32/68/0 | PVDF | 2.5 | 43 | B | 7 | A |
| Example 21 | 90/0/10 | PI | 0.5 | 59 | A | 4 | AA |
| Example 22 | 90/0/10 | PI | 1.0 | 60 | A | 8 | A |
| Example 23 | 90/0/10 | PI | 1.5 | 59 | A | 4 | AA |
| Example 24 | 90/0/10 | PI | 2.0 | 60 | A | 8 | A |
| Example 25 | 90/0/10 | PI | 2.5 | 59 | A | 4 | AA |
| Example 26 | 0/90/10 | PI | 0.5 | 65 | A | 4 | AA |
| Example 27 | 0/90/10 | PI | 1.0 | 66 | A | 6 | A |
| Example 28 | 0/90/10 | PI | 1.5 | 65 | A | 4 | AA |
| Example 29 | 0/90/10 | PI | 2.0 | 66 | A | 6 | A |
| Example 30 | 0/90/10 | PI | 2.5 | 66 | A | 6 | A |
| Example 31 | 29/61/10 | PI | 0.5 | 71 | A | 3 | AA |
| Example 32 | 29/61/10 | PI | 1.0 | 68 | A | 5 | A |
| Example 33 | 29/61/10 | PI | 1.5 | 71 | A | 3 | AA |
| Example 34 | 29/61/10 | PI | 2.0 | 71 | A | 3 | AA |
| Example 35 | 29/61/10 | PI | 2.5 | 68 | A | 5 | A |
| Example 36 | 32/68/0 | PI | 0.5 | 70 | A | 3 | AA |
| Example 37 | 32/68/0 | PI | 1.0 | 66 | A | 7 | A |
| Example 38 | 32/68/0 | PI | 1.5 | 70 | A | 3 | AA |
| Example 39 | 32/68/0 | PI | 2.0 | 70 | A | 3 | AA |
| Example 40 | 32/68/0 | PI | 2.5 | 66 | A | 7 | A |
| Example 41 | 29/61/10 | PAI | 1.5 | 72 | A | 4 | AA |
| Example 42 | 29/61/10 | PAI | 2.0 | 70 | A | 5 | A |

TABLE 2

| | Negative | | | | | | |
|---|---|---|---|---|---|---|---|
| | electrode active | | | | | | |
| | material | Negative | Biphenyl | Cycle characteristics at 60° C. | | | |
| | Si/SiO_{x/}C | electrode | content | Retention rate | | Bulge rate | |
| | (wt ratio) | binder | (wt %) | % | Evaluation | % | Evaluation |
| Comparative | 90/0/10 | PVDF | 0 | 41 | B | 38 | C |
| Example 1 | | | | | | | |
| Comparative | 0/90/10 | PVDF | 0 | 43 | B | 32 | C |
| Example 2 | | | | | | | |
| Comparative | 29/61/10 | PVDF | 0 | 43 | B | 32 | C |
| Example 3 | | | | | | | |
| Comparative | 32/68/0 | PVDF | 0 | 44 | B | 32 | C |
| Example 4 | | | | | | | |
| Comparative | 90/0/10 | PI | 0 | 57 | A | 35 | C |
| Example 5 | | | | | | | |
| Comparative | 0/90/10 | PI | 0 | 65 | A | 33 | C |
| Example 6 | | | | | | | |
| Comparative | 29/61/10 | PI | 0 | 71 | A | 31 | C |
| Example 7 | | | | | | | |
| Comparative | 32/68/0 | PI | 0 | 70 | A | 32 | C |
| Example 8 | | | | | | | |
| Comparative | 90/0/10 | PVDF | 3.0 | 41 | B | 27 | C |
| Example 9 | | | | | | | |
| Comparative | 0/90/10 | PVDF | 3.0 | 44 | B | 22 | C |
| Example 10 | | | | | | | |
| Comparative | 29/61/10 | PVDF | 3.0 | 41 | B | 26 | C |
| Example 11 | | | | | | | |
| Comparative | 32/68/0 | PVDF | 3.0 | 44 | B | 25 | C |
| Example 12 | | | | | | | |
| Comparative | 90/0/10 | PI | 3.0 | 59 | A | 26 | C |
| Example 13 | | | | | | | |
| Comparative | 0/90/10 | PI | 3.0 | 65 | A | 21 | C |
| Example 14 | | | | | | | |
| Comparative | 29/61/10 | PI | 3.0 | 67 | A | 22 | C |
| Example 15 | | | | | | | |
| Comparative | 32/68/0 | PI | 3.0 | 62 | A | 25 | C |
| Example 16 | | | | | | | |

TABLE 3

| | Negative electrode | Negative | Biphenyl | | Dispersion | Fluori- | Cycle characteristics at 60° C. | | | |
|---|---|---|---|---|---|---|---|---|---|---|
| | active material | electrode | content | Amorphous | of | nated | Retention rate | | Bulge rate | |
| | Si/SiOₓ/C (wt ratio) | binder | (wt %) | SiOₓ | Si in SiOₓ | ether | % | Evaluation | % | Evaluation |
| Example 43 | 29/61/10 | PI | 0.5 | Present | Absent | Absent | 75 | A | 2 | AA |
| Example 44 | 29/61/10 | PI | 1.0 | Present | Absent | Absent | 73 | A | 4 | AA |
| Example 45 | 29/61/10 | PI | 1.5 | Present | Absent | Absent | 73 | A | 4 | AA |
| Example 46 | 29/61/10 | PI | 2.0 | Present | Absent | Absent | 75 | A | 2 | AA |
| Example 47 | 29/61/10 | PI | 2.5 | Present | Absent | Absent | 73 | A | 4 | AA |
| Example 48 | 29/61/10 | PI | 0.5 | Present | Present | Absent | 83 | AA | 3 | AA |
| Example 49 | 29/61/10 | PI | 1.0 | Present | Present | Absent | 83 | AA | 3 | AA |
| Example 50 | 29/61/10 | PI | 1.5 | Present | Present | Absent | 82 | AA | 4 | AA |
| Example 51 | 29/61/10 | PI | 2.0 | Present | Present | Absent | 83 | AA | 3 | AA |
| Example 52 | 29/61/10 | PI | 2.5 | Present | Present | Absent | 82 | AA | 4 | AA |
| Example 53 | 29/61/10 | PI | 1.5 | Present | Present | Present | 85 | AA | 3 | AA |
| Example 54 | 29/61/10 | PI | 2.0 | Present | Present | Present | 84 | AA | 4 | AA |
| Example 55 | 29/61/10 | PI | 0.5 | Present | Present | Absent | 86 | AA | 3 | AA |
| Example 56 | 29/61/10 | PI | 1.0 | Present | Present | Absent | 87 | AA | 3 | AA |
| Example 57 | 29/61/10 | PI | 1.5 | Present | Present | Absent | 87 | AA | 4 | AA |
| Example 58 | 29/61/10 | PI | 2.0 | Present | Present | Absent | 87 | AA | 4 | AA |
| Example 59 | 29/61/10 | PI | 2.5 | Present | Present | Absent | 86 | AA | 4 | AA |
| Example 60 | 29/61/10 | PI | 1.5 | Present | Present | Present | 88 | AA | 3 | AA |
| Example 61 | 29/61/10 | PI | 2.0 | Present | Present | Present | 87 | AA | 4 | AA |

As shown in Tables 1 to 3, the secondary batteries prepared in Examples 1 to 61 had satisfactory low bulge rates at 60° C. compared to bulge rates at 60° C. of the secondary batteries prepared in Comparative Examples 1 to 16. From the results, it was demonstrated that according to the exemplary embodiment, a secondary battery having high-temperature cycle characteristics can be obtained. Furthermore, from the results of Examples 48 to 61, it was demonstrated that the retention rate at 60° C. is increased by using a negative-electrode active material in which a metal oxide (b) has an amorphous structure and a metal (a) is dispersed in the metal oxide (b). Furthermore, from the results of Examples 53, 54, 60 and 61, the retention rate at 60° C. is further increased by using a nonaqueous electrolyte containing a fluorinated ether compound.

While the present invention has been described with reference to the exemplary embodiments and Examples, the present invention is not limited to the above exemplary embodiments and Examples. Various changes that can be understood by those skilled in the art may be made to the constitution and details of the present invention within the scope thereof.

This application claims the right of priority based on Japanese Patent Application No. 2010-196626 filed on Sep. 2, 2010, the entire content of which is incorporated herein by reference.

### INDUSTRIAL APPLICABILITY

The exemplary embodiment can be used in various industrial fields requiring power supply and the industrial fields of transporting, storing and supplying electric energy. Specifically, for example, the exemplary embodiment can be used as a power supply for mobile equipment such as mobile telephones and note PCs; a power supply for transfer or transportation medium including electric vehicles such as electric cars, hybrid cars, electric motorcycles, electric assist bicycles and electric trains, satellites and submarines; backup power supply such as UPS; and storage equipment for storing electric power obtained by photovoltaic power generation and wind-generated electricity.

### REFERENCE SIGNS LIST

1 Negative electrode
2 Separator
3 Positive electrode
4 Negative electrode current collector
5 Positive electrode current collector
6 Positive electrode terminal
7 Negative electrode terminal

1. A laminate type secondary battery comprising: an electrode element comprising an electrode pair in which a positive electrode and a negative electrode are arranged so as to face each other; an electrolyte; and a jacket housing the electrode element and the electrolyte,
wherein the negative electrode comprises a negative-electrode active material comprising at least one of a metal (a) capable of forming an alloy with lithium and a metal oxide (b) capable of absorbing and desorbing lithium ions, a negative electrode binder and a negative electrode current collector;
the electrolyte contains a nonaqueous solvent and biphenyl; and the content of the biphenyl in the electrolyte is 0.5 to 2.5% by mass, based on the total of the nonaqueous solvent and the biphenyl.

2. The secondary battery according to claim 1, wherein the content of the biphenyl in the electrolyte is 1 to 2% by mass, based on the total of the nonaqueous solvent and the biphenyl.

3. The secondary battery according to claim 1, wherein the positive electrode binder is polyimide or polyamide imide.

4. The secondary battery according to claim 1, wherein the negative-electrode active material further comprises a carbon material (c) capable of absorbing and desorbing lithium ions.

5. The secondary battery according to claim 1, wherein the negative-electrode active material contains both the metal (a) and the metal oxide (b).

6. The secondary battery according to claim 5, wherein the metal oxide (b) is an oxide of a metal constituting the metal (a).

7. The secondary battery according to claim 5, wherein the metal (a) is wholly or partly dispersed in the metal oxide (b).

8. The secondary battery according to claim 1, wherein the metal oxide (b) wholly or partly includes an amorphous structure.

9. The secondary battery according to claim 1, wherein the metal (a) is silicon.

10. The secondary battery according to claim 5, wherein the metal (a) is silicon and the metal oxide (b) is a silicon oxide.

11. The secondary battery according to claim 1, wherein the electrolyte contains a fluorinated ether compound.

12. The secondary battery according to claim 1, wherein the jacket is formed of an aluminum laminate film.

13. The secondary battery according to claim 1, wherein the jacket is formed of a laminate film.
